(19) United States
(12) Patent Application Publication
(10) Pub. No.: US 2026/0123621 A1
(43) Pub. Date: May 7, 2026

(54) AGRICULTURAL SPRAYER WITH SPOT SPRAY CONTROL

(71) Applicant: DEERE & COMPANY, MOLINE, IL (US)

(72) Inventors: Andrew Muehlfeld, St. Paul, MN (US); Eric Taipale, St. Paul, MN (US); Nicholas Witthoeft, St. Paul, MN (US)

(21) Appl. No.: 19/317,738

(22) Filed: Sep. 3, 2025

Related U.S. Application Data
(60) Provisional application No. 63/715,073, filed on Nov. 1, 2024.

(51) Int. Cl. A01M 7/00; A01C 23/00; A01C 23/04

(52) U.S. Cl. CPC A01M 7/0089; A01C 23/007; A01C 23/047

(57) ABSTRACT

An agricultural sprayer with a spot spray control system. Spray data together with one or more dynamic factors arising during operation of the agricultural sprayer and/or one or more sprayer-specific characteristics of the agricultural sprayer are used in real-time to control nozzles of the agricultural sprayer to control the spraying of a liquid from the nozzles. The nozzle control may include determining one or more of nozzle selection, nozzle state change timing, nozzle flow rate, and other operational characteristics of the nozzles.

### CROSS-REFERENCE TO RELATED APPLICATIONS

This application claims the benefit of U.S. Provisional Application No. 63/715,073, filed on 1 November 2024, the disclosure of which is incorporated by reference.

### FIELD

The technology described herein relates to precision agriculture.

### BACKGROUND

In agriculture, the use of sprayers to apply liquids in crop fields is known. Examples of liquids include, but are not limited to, pesticides and fertilizers. Pesticides include herbicides, fungicides, insecticides, and the like. In the example case of a herbicide to be applied on a weed, it is desirable to spray only the weed in order to minimize herbicide usage, which saves money, reduces negative environmental and health impacts of herbicide, and reduces injury to the crop which can reduce yield and profit. One approach for reducing herbicide usage is referred to as on-machine or proximal sensing. These proximal systems detect weeds with cameras mounted on the boom of a sprayer, then actuate nozzles to spray the detected weeds in real time. Weed detection and spraying of the herbicide occur on the same vehicle, within seconds of each other.

Another approach involving herbicide usage control is to capture images of a field using an unmanned aerial vehicle (UAV) or drone, process the images to detect weeds in the field, then generate a weed prescription file which is then imported to a sprayer. The sprayer uses the weed prescription file to spray the areas prescribed by the weed prescription file. To account for various error sources which are not known at the time of generating the weed prescription file, the weed prescription file that is generated includes buffers applied to the weed data so that the nozzle of the sprayer sprays a larger area to ensure the weed receives herbicide. For example, for any particular weed, the buffer may be a length of 2 or 3 meters before and after the weed in the direction of travel of the sprayer to ensure that herbicide is actually applied to the weed. Another example is turning on additional nozzles to act as a width buffer to ensure that herbicide is actually applied to the weed. However, applying the buffer(s) to spray a larger area increases the amount of herbicide used and reduces savings.

### SUMMARY

An agricultural sprayer with real-time spot spray control is described. Spray location data together with one or more dynamic factors arising during operation of the agricultural sprayer and/or one or more sprayer-specific characteristics of the agricultural sprayer are used in real-time to control nozzles of the agricultural sprayer to control the spraying of a liquid from the nozzles. The nozzle control can include, but is not limited to, one or more of nozzle selection, nozzle flow rate, and nozzle state change timing.

The liquid that is sprayed by the agricultural sprayer can be any liquid that is applied to an agricultural field by an agricultural sprayer. Examples of liquids include, but are not limited to, pesticides and fertilizers (these liquids may generally be referred to collectively as agricultural field liquids). Examples of pesticides include, but are not limited to, herbicides, fungicides, and insecticides. Additional examples of pesticides that can be used include those defined at www.epa.gov/safepestcontrol/why-we-use-pesticides.

Examples of dynamic factors that may be used in the spot spray control described herein include, but are not limited to, one or more of boom height, nozzle velocity, and air velocity.

Examples of sprayer-specific characteristics that may be used in the spot spray control described herein include, but are not limited to, one or more of nozzle specifications, nozzle delay timing, and nozzle layout.

The spray location data provides location data, such as coordinate positions on Earth or locations determined relative to camera(s) or other objects on the agricultural sprayer, where spraying is to occur. In an embodiment, the spray location data may be generated away from the agricultural sprayer, for example based on analysis of images captured by a UAV, and then saved on the agricultural sprayer. The spray location data may be in the form of a spray instructions file that is stored in suitable storage on the agricultural sprayer. In another embodiment, the spray location data may result from on-machine or proximal sensing, where the locations are determined relative to the cameras on the agricultural sprayer (or other objects on the sprayer) used to capture images as the sprayer traverses the field. Spray location data generated away from the agricultural sprayer can be generated prior to the sprayer beginning to spray the field. For example, UAV imagery may be captured a period of time before spraying, such as 1 or 2 hours or one day before spraying. In addition to a spray locations file, the UAV images may be analyzed to determine what types of pests are in the field. In the case of an herbicide application, the UAV images may be used to determine what types of weeds are in a field. Different types of weeds are treated with different types of herbicide. Generating spray location data away from the sprayer prior to spraying provides useful information such as how much liquid is required to treat the field and what type of pesticide is required based on the type of pests in the field. This information can be used to load a sprayer with the appropriate volume of liquid(s), and the optimal type of liquid(s), maximizing pest control and minimizing waste.

A system described herein can include an agricultural sprayer that includes a spray boom with nozzles that are controllable to be turned on and off. Spray location data is stored on the agricultural sprayer, and a controller on the agricultural sprayer is connected to and controls operation of the nozzles to spray a liquid based on the spray location data and one or more of the following: a) one or more dynamic factors during operation of the agricultural sprayer; and/or b) one or more sprayer-specific characteristics of the agricultural sprayer.

A spray boom of an agricultural sprayer includes nozzles that are controllable to be turned on and off. The spray boom also includes one or more boom height sensors, one or more air velocity sensors, and one or more navigation sensors thereon.

A system can also include an agricultural sprayer that includes a spray boom with nozzles that are controllable to be turned on and off. Spray location data is stored on the agricultural sprayer, and a controller on the agricultural sprayer is connected to and controls operation of the nozzles using to the spray location data and nozzle state change timing of at least one of the nozzles.

A system can also include an agricultural sprayer that includes a spray boom with nozzles that are controllable to be turned on and off; spray location data stored on the agricultural sprayer; and a controller on the agricultural sprayer that is connected to and controls operation of the nozzles to spray a liquid based on the spray location data, nozzle specifications, and boom height.

A system can also include an agricultural sprayer that includes a spray boom with nozzles that are controllable to be turned on and off; and a controller on the agricultural sprayer that is connected to and makes nozzle selection decisions to control operation of the nozzles to spray a liquid, and the nozzle decisions are based on spray location data, nozzle fan angle, and boom height.

A system can also include an agricultural sprayer that includes a spray boom with nozzles that are controllable to be turned on and off; and a controller on the agricultural sprayer that is connected to and controls operation of the nozzles based on boom dynamics. In an embodiment, the boom dynamics informed nozzle control is used to achieve a consistent target application rate in a broadcast application or a spot spray application by controlling nozzle flow rate. In another embodiment, the boom dynamics informed nozzle control is used to accurately spot spray by controlling nozzle state change timing.

A system can also include an agricultural sprayer that includes a spray boom with nozzles that are controllable to be turned on and off; and a controller on the agricultural sprayer that is connected to and controls operation of the nozzles based on air velocity to increase spot spray accuracy with both spray location data resulting from UAV image analysis or spray location data resulting from proximal sensing.

A system can also include an agricultural sprayer that includes a spray boom with nozzles that are controllable to be turned on and off, and at least one sensor that measures nozzle delay timing.

A method can include loading a sprayer with a type of pesticide determined based on types of pests present in a field determined based on UAV imagery.

### DRAWINGS

FIG. 1 depicts a precision agriculture system.

FIG. 2 is a rear view of an embodiment of a spray boom of an agricultural sprayer that can implement the concepts described herein.

FIG. 3 is a rear view of another embodiment of a spray boom of an agricultural sprayer that can implement the concepts described herein.

FIG. 4 is a rear view of another embodiment of a spray boom of an agricultural sprayer that can implement the concepts described herein.

FIG. 5 is a rear view of another embodiment of a spray boom of an agricultural sprayer that can implement the concepts described herein.

FIG. 6 is a rear view of another embodiment of a spray boom of an agricultural sprayer that can implement the concepts described herein.

FIG. 7 is a rear view of another embodiment of a spray boom of an agricultural sprayer that can implement the concepts described herein.

FIG. 8 is a schematic depiction of nozzle groups on the spray boom of the agricultural sprayer described herein.

FIGS. 9A-D illustrate different embodiments of determining nozzle delay timing of a nozzle of the spray boom.

FIG. 10 is a top view of a spray boom depicting forward rotation of the spray boom.

FIG. 11 is a top view of a spray boom depicting forward rotation and flexure of the spray boom.

FIG. 12 is a rear view of a spray boom depicting upward and downward rotation and flexure of the spray boom.

FIG. 13 is a schematic rear view of a portion of a spray boom depicting an example of the area on the ground covered by spray from each nozzle.

FIG. 14 is a flow chart of the spot spray control system.

### DETAILED DESCRIPTION

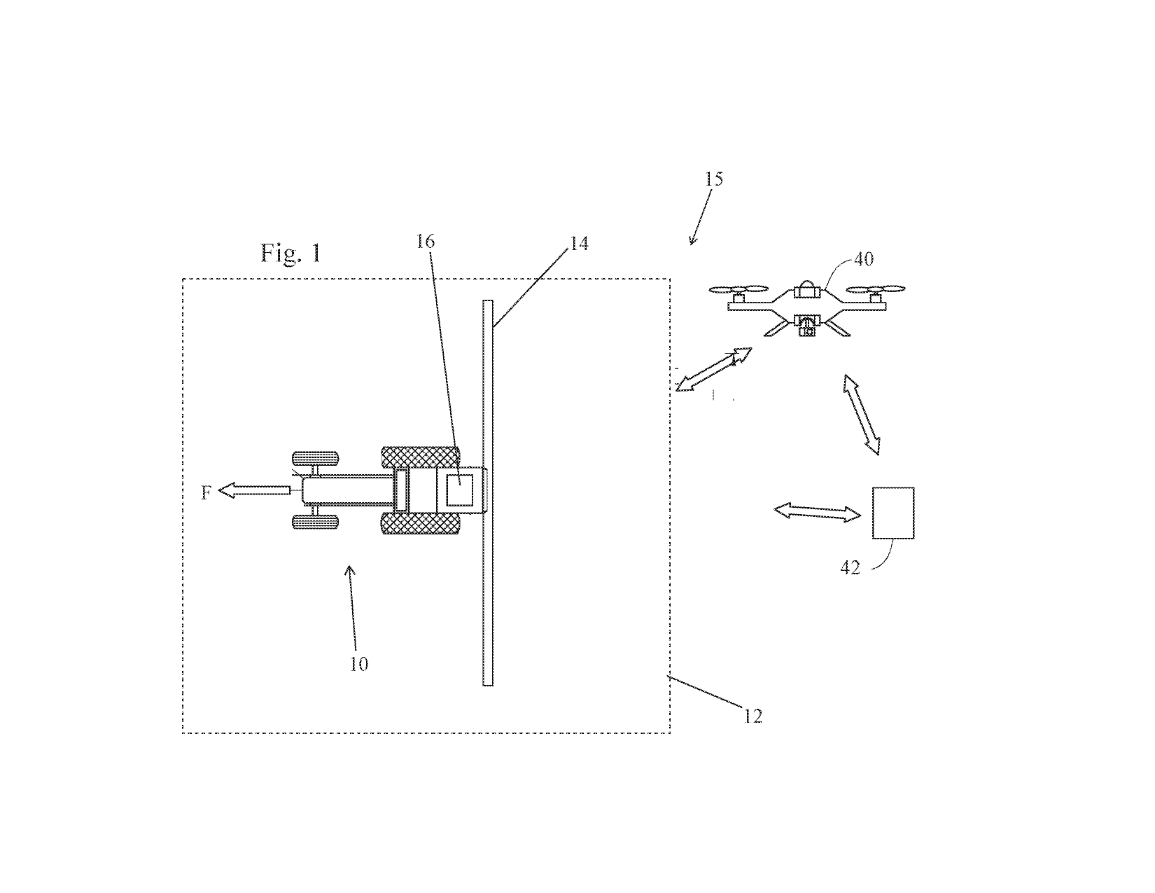

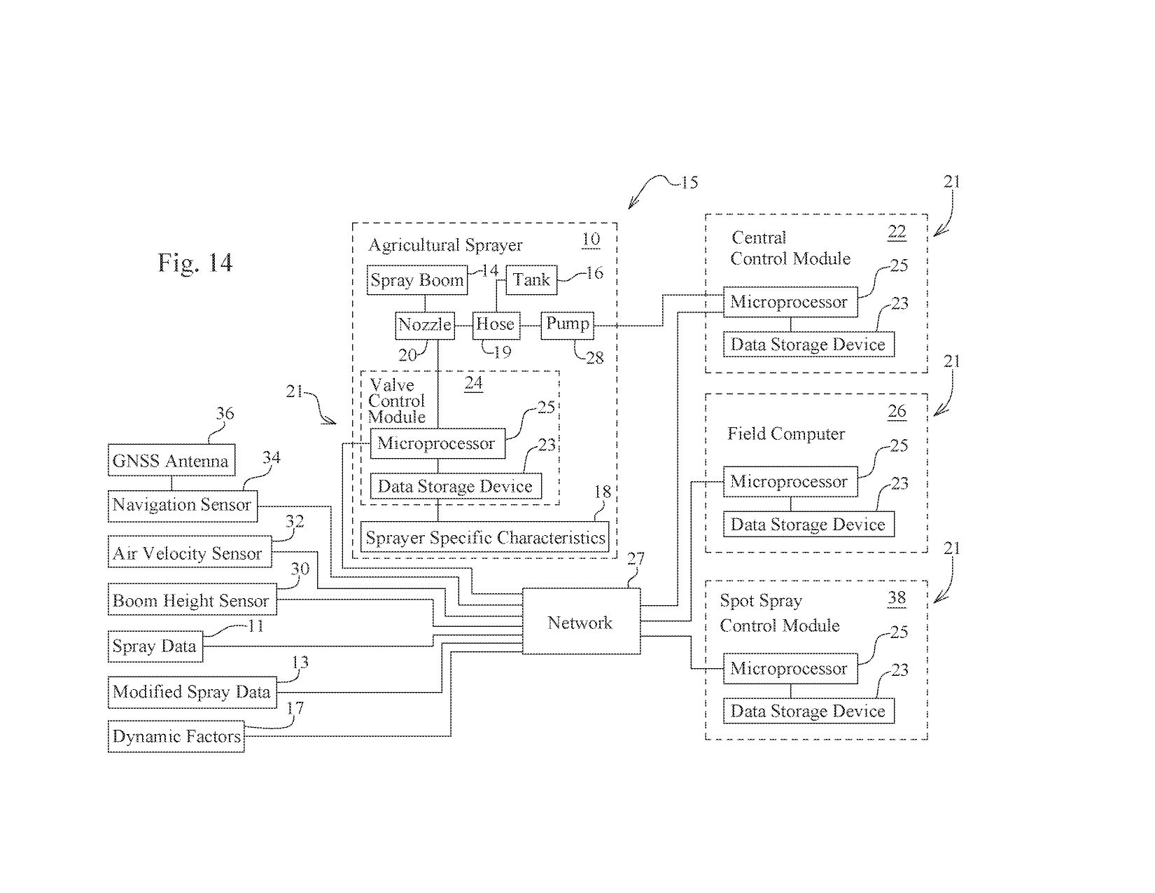

FIG. 1 depicts an example of a system that includes an agricultural sprayer 10 that implements spot spray control. In the spot spray control system 15 described herein (see FIGS. 1 and 14), spray data 11 that is used to control the spraying of a liquid from one or more nozzles of the agricultural sprayer 10 is modified in real-time on the agricultural sprayer 10 to generate modified spray data 13. The spray data 11 is modified using one or more dynamic factors 17 during operation of the agricultural sprayer 10 and/or using one or more sprayer-specific characteristics 18 of the agricultural sprayer 10 to generate modified spray data 13. The modified spray data 13 is then used to control operation of nozzles of the sprayer 10 and control the application of the liquid by the sprayer 10.

The sprayer 10 comprises an agricultural machine that traverses an agricultural field 12 to apply a liquid to the field 12. The liquid that is sprayed by the sprayer 10 can be any liquid that is applied to an agricultural field 12 by a sprayer 10. Examples of liquids include, but are not limited to, pesticides and fertilizers (these liquids may generally be referred to collectively as agricultural field liquids). Examples of pesticides include, but are not limited to, herbicides, fungicides, and insecticides. Additional examples of pesticides that can be used include those defined at www.epa.gov/safepestcontrol/why-we-use-pesticides. The agricultural sprayer 10 may apply a single liquid or simultaneously apply multiple liquids. Applying a liquid includes applying the liquid to the ground or soil, applying a liquid to a crop plant, applying a liquid to a weed, or any other application of liquid in an agricultural setting.

In this example, the sprayer 10 is a terrestrial sprayer which drives on the ground. The sprayer 10 can be manned or unmanned. The sprayer 10 can be self-propelled or a pull-behind sprayer. An example of a self-propelled sprayer is the John Deere 412R.

The description below may refer to application of herbicide to weeds as one example of applying a liquid from an agricultural sprayer. However, the concepts described herein can be used to control application of fungicide to crop plants, control the application of fertilizer to the soil or crop plants, and control the application of insecticide to insects, crop plants or soil.

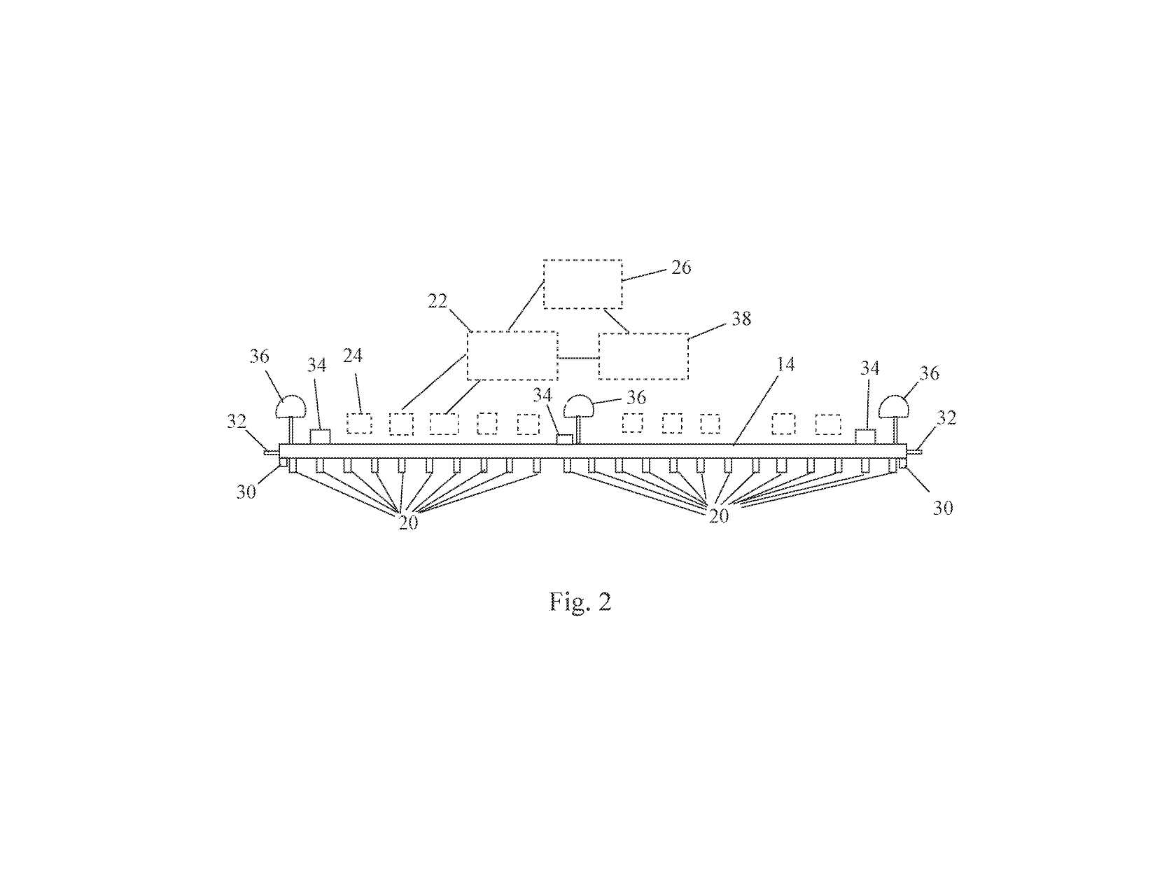

The sprayer 10 includes a spray boom 14 (or boom 14). The spray boom 14 carries nozzles 20 (illustrated in FIGS. 2-8) along its length. The sprayer 10 further includes at least one tank 16, fluidly connected to the nozzles, that carries the liquid(s) to be sprayed from the nozzles 20. In an embodiment, the sprayer 10 may have two or more tanks 16, two or more sets of hoses, and two or more sets of nozzles to spray two or more different liquids independently. In another embodiment, the sprayer 10 may have two tanks 16 for two different liquids, a combined set of hoses, and one set of shared nozzles 20 to spray different combinations of the two liquids from the two tanks 16 using the same nozzles 20.

FIG. 2 is a rear view of the spray boom 14 of the sprayer 10. The spray boom 14 is depicted as including nozzles 20 that are spaced from one another along the length of the spray boom 14. Each nozzle 20 atomizes the liquid for even distribution over the field 12. On conventional sprayers 10, the nozzles 20 are typically spaced from one another at 10, 15, 18, 20, or 24 inches. However, other spacing can be used. In addition, the number of nozzles 20 on the spray boom 14 can also vary. Each nozzle 20 is part of a nozzle assembly that includes an electrically controllable valve, such as a solenoid valve, that controls the flow of liquid to the nozzle 20 and that is used to set the flow.

The sprayer 10 can also include one or more controllers 21 including a central control module 22, a valve control module 24, or a field computer 26. The controllers 21 may include a data storage device 23 and a microprocessor 25. The spot spray control system 15, and/or the controllers 21, may communicate with the agricultural sprayer 10 over a network 27 such as a CAN bus or the controllers 21 may be wired directly. The data storage device 23 may be configured for storing instructions that are executable by the microprocessor 25 to cause the microprocessor 25 to receive signals (for example signals indicative of spray data 11, dynamic factors 17, and sprayer specific characteristics 18), perform analysis, and transmit control signals (for example modified spray data 13).

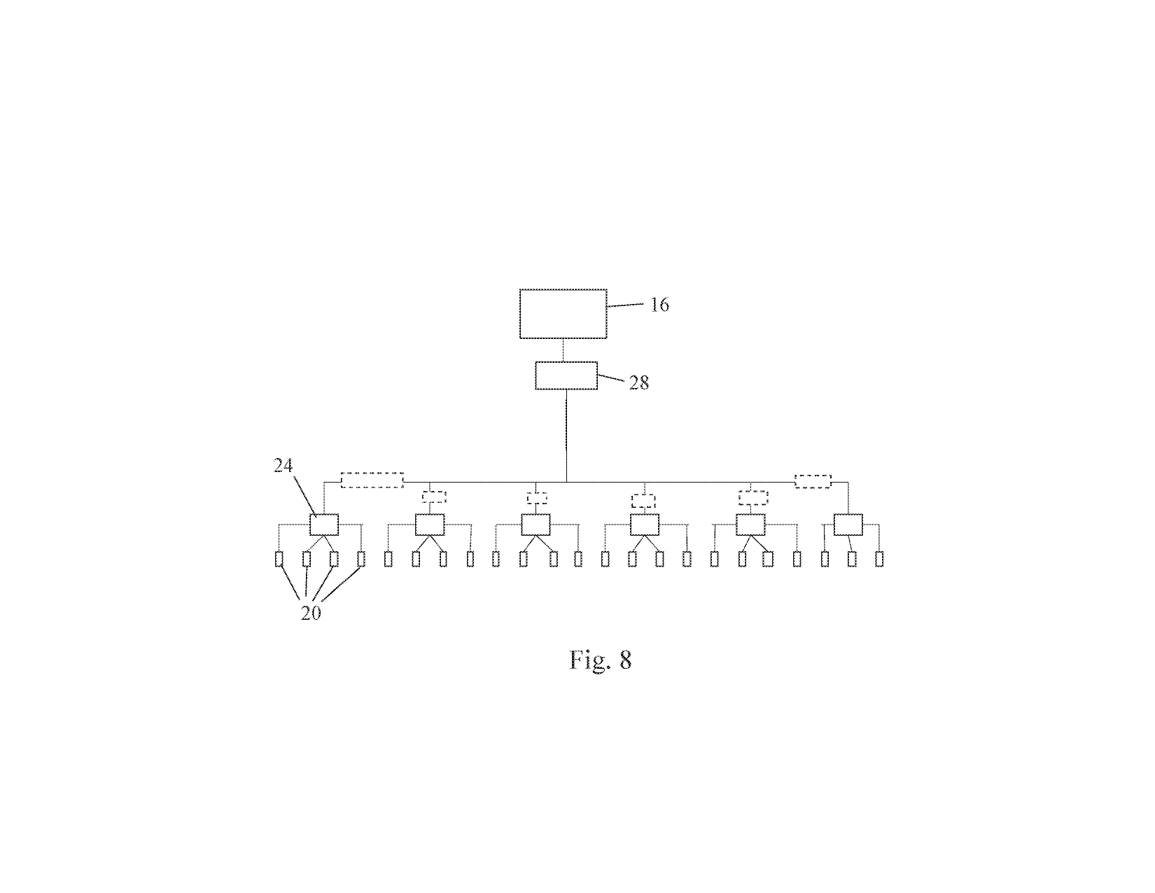

The central control module 22, which may also be referred to as a rate control module or a rate controller, controls the valve control modules 24 and communicates with the field computer 26 (which may also be referred to as a field controller 26). The central control module 22 may monitor liquid pressure, control a pump 28 (FIG. 8) that pumps the liquid from the tank 16 via a series of hoses 19, control individual valves or groups of valves of the nozzles 20, and control the valve control modules 24. The central control module 22 controls pressure in the hoses 19 by varying the pump speed or turning the pump on or off, and controls all of the valve control modules 24 with on/off commands and/or pulse width commands. A valve control module 24 can control a single valve of a single nozzle 20 or control the valves of a group of nozzles 20 as depicted in FIG. 8.

The field computer 26 is used to control the nozzles 20 and spray rates (e.g. gallons per acre). The field computer 26 is sometimes referred to as a display. Examples of field computers include the John Deere 4600 Command Center. The field computer 26 may have a touch screen interface. The field computer 26 may also control many aspects of the sprayer 10 via separate physical buttons, joysticks, and other human-machine interface devices. The field computer 26 is often the primary interface for the sprayer operator (driver) for operating the sprayer 10 and providing operator input.

If the field computer 26 does not have sufficient computation capacity to calculate nozzle location and make nozzle selection, nozzle state change timing, and nozzle flow rate decisions at a sufficient rate, for example 50Hz, the field computer 26 may control the central control module 22 or another controller 21 such as a spot spray control module 38 (described further below) with sufficient computation capacity can be added to the spot spray control system 15.

Controlling of the nozzles 20 can mean directly controlling a valve of a nozzle assembly or communicating with the valve control module 24 to control the nozzles 20, or communicating with the central control module 22 to control the nozzles 20. The controlling of the nozzles 20 can be performed by the field computer 26, the spot spray control module (described below), the central control module 22, or the valve control modules 24.

Returning to FIG. 2, the spray boom 14 can include a number of sensors along its length. For example, in one embodiment, the spray boom 14 can include a boom height sensor 30 adjacent each end thereof and/or at other locations along the length of the spray boom 14. The boom height sensor 30 is configured to measure the height of the spray boom 14 above the crop or weeds or above the agricultural field 12 at that location of the boom height sensor 30. The boom height impacts the height of the nozzles 20 above the ground or the crop or the weeds. The term “boom height” is a standard industry term that also means nozzle height. Each boom height sensor 30 can be an ultrasound sensor, a radar, or a laser range finder.

With continued reference to FIG. 2, the spray boom 14 may include an air velocity sensor 32 at each end thereof or at other locations along the length of the spray boom 14. Atomized liquid from a nozzle 20 travels as droplets from the nozzle 20 through the air to plants, weeds, or ground. In a vacuum, the droplets would follow a ballistics trajectory with an initial state determined by the nozzle velocity (i.e. the velocity at which the nozzle 20 is traveling), and accelerating toward the ground. However, in agricultural fields 12 air influences the movement of the droplets. If the air is moving, such as from wind or disturbance from the boom 14, the droplet trajectory will be heavily influenced by the air mass it travels through. The air velocity sensor(s) 32 mounted on the spray boom 14 provides air velocity measurements that can be used to determine nozzle selection (i.e. which nozzles to turn on) and nozzle state change timing (i.e. when to turn a nozzle on or off). The air velocity sensor(s) 32 may measure true velocity including both speed and direction, or measure speed with respect to one direction as in the case of a pitot tube. The air velocity sensors 32 measure air velocity relative to its position. If the sprayer 10 is moving, the measured air velocity is relative to the air velocity sensor 32 rather than relative to the ground (e.g. wind velocity). Nozzle velocity and relative air velocity can be used to estimate droplet trajectory, and the estimated droplet trajectory can be used to determine nozzle selection, nozzle state change timing, and nozzle flow rate. Examples of air velocity sensors 32 include, but are not limited to, sonic anenometers, ultrasonic anenometers, pitot tubes, vanes, cups, hot wires, differential pressure sensors, and anenomoters. The air velocity sensor(s) 32 can be composed of multiple air speed sensors oriented in different directions, and the speed measurements are combined with the sensor orientation to determine speed and direction. In an embodiment, air velocity can be provided from one or more external systems (i.e. external to the sprayer 10), such as a weather station at or nearby the agricultural field 12. If the air velocity is provided from one or more external systems, the externally provided air velocity may be used by itself, used together with measurements from the sensors 32, or used to modify the measurements from the air velocity sensors 32. Air velocity measurements from an external system measure air velocity relative to that external system rather than relative to the spray boom 14. If the external system is stationary, the air velocity measured is relative to the external system and may be referred to as wind speed. Air velocity measurements from an external system are intended to be encompassed within the meaning of a dynamic factor as described herein. Air velocity measurements may measure air velocity relative to the sprayer 10 or may measure air velocity relative to the ground or a stationary object.

The spray boom 14 may also include one or more navigation sensors 34 thereon. For example, FIG. 2 depicts three navigation sensors 34 on the spray boom 14, one navigation sensor 34 adjacent each end of the spray boom 14 and one navigation sensor 34 at or adjacent to the center of the spray boom 14. Each navigation sensor 34 determines its location, and each navigation sensor 34 may also determine its orientation and its velocity. Each navigation sensor 34 has an associated Global Navigation Satellite Systems (GNSS) antenna 36 and a GNSS receiver. As used herein, GNSS includes, but is not limited to, Global Positioning System (GPS), Galileo, and Beidou. Each navigation sensor 34 may include an Inertial Navigation System (INS) or Inertial Measurement Unit (IMU), which measures acceleration and rotation to determine orientation and improve accuracy of location. One or more of the navigation sensors 34 may also implement real-time kinematic (RTK) positioning by receiving corrections from a corrections source such as a base station or a virtual service. The navigation sensor 34 may be near the GNSS antenna 36, such as within a few feet, or may be far from the GNSS antenna 36, such as near a cab of the sprayer 10. If the navigation sensor 34 includes an INS or IMU, it is likely to be close to the GNSS antenna. If the navigation sensor 34 does not include an INS or IMU, the navigation sensor 34 can be located anywhere as long as it is connected to the GNSS antenna 36.

A spot spray control module 38 may also be provided. The spot spray control module 38 receives data such as but not limited to spray data 11, including spray location data, a spray instructions file that contains the spray location data, dynamic data variables (i.e. dynamic factors), and sprayer-specific characteristics 18, and based on that data determines how the nozzles 20 should be controlled. For example, the spot spray control module 38 can determine one or more of nozzle selection, nozzle state change timing, and nozzle flow rate. In an embodiment, the central control module 22, the field computer 26, and the spot spray control module 38 are all included on and part of the sprayer 10. In another embodiment, one or more of the central control module 22, the field computer 26, and the spot spray control module 38 may be implemented in devices that are ancillary to and brought onto the sprayer 10 and communicate with the sprayer 10 over the network 27 such as a laptop computer, a mobile phone, or the like. In an embodiment, the central control module 22 and the spot spray control module 38 may be combined together into a single element. In an embodiment, the central control module 22, the spot spray control module 38, and the field computer 26 may be combined together into a single element. In an embodiment, the central control module 22 and the field computer 26 may be combined together into a single element. In an embodiment, the spot spray control module 38 and the field computer 26 may be combined together into a single element.

The spray data 11 including the spray location data that is provided to the spot spray control module 38 can be provided in any suitable manner. The spray location data provides location data, such as coordinate positions on Earth or locations determined relative to camera(s) or other objects on the agricultural sprayer 10, where spraying is to occur. In an embodiment, the spray location data may be generated away from the agricultural sprayer 10, for example based on analysis of images captured by a UAV 40 (FIG. 1), and then saved on the agricultural sprayer 10. When generated away from the sprayer 10, the spray location data may be in the form of a spray instructions file that is stored in suitable storage on the agricultural sprayer 10. In another embodiment, the spray location data may result from on-machine or proximal sensing, where the locations are determined relative to the sensors or cameras on the agricultural sprayer 10 (or other objects on the sprayer) used to capture images as the sprayer 10 traverses the field 12.

For example, in an embodiment involving weeds and the application of herbicide, the spray location data can be provided from an on-machine or proximal sensing system that detects weeds using cameras mounted on the spray boom 14 or mounted elsewhere on the agricultural sprayer 10. That spray location data resulting from the on-machine or proximal sensing system may be provided to the spot spray control module 38 and may be stored, for example on the spot spray control module 38. The spray data 11 and one or more dynamic factors 17 during operation of the agricultural sprayer 10 and/or one or more sprayer-specific characteristics 18 of the agricultural sprayer 10 are then used to control operation of the nozzles 20.

In another embodiment involving weeds and the application of herbicide and off-sprayer generation of the spray location data, the spray location data can be a list of weed locations (i.e. locations indicating where spraying is to occur) that is generated by a system separate from the agricultural sprayer 10 and that is then stored on the agricultural sprayer 10. For example, referring to FIG. 1, the UAV 40 can be flown over the field 12 to capture images of the field 12. The captured images can then be analyzed by a controller 21, for example on the UAV 40 or in a separate analysis system 42, such as a ground control station, laptop computer, one or more cloud servers, and the like. The image analysis includes identifying weeds, plants, or other objects in the images, and in the case of weeds, generating a list of weed locations. The list of weed locations or other spray location data is then stored on the agricultural machine 10, for example in suitable the data storage device 23 on or accessible by the spot spray control module 38. The spray location data, such as the weed locations, and one or more dynamic factors 17 during operation of the agricultural sprayer 10 and/or one or more sprayer-specific characteristics 18 of the agricultural sprayer 10 are then used to control operation of the nozzles 20. The term location, for example as in weed location, refers to position on Earth, such as latitude and longitude in WGS 84, or easting and northing in a UTM coordinate system such as UTM15N. In an embodiment, location may also include altitude. In the case of nozzle location data, the location data may also be augmented with velocity and orientation data.

In a conventional system, a spot spray prescription is generated and provided to the agricultural sprayer 10. The spot spray prescription is a file, often an ESRI format shapefile, indicating which areas to spray and which areas not to spray. These files are commonly referred to as prescriptions, shapefiles, scripts, Rx, recommendations, or recs. In a conventional spot spray prescription, system error and dynamic system parameters are estimated and built into the shapefile in the form of pre-generated buffers, and the spot spray prescription is implemented by the agricultural sprayer 10 to spray the field 12.

The pre-generated buffers in a conventional spot spray prescription may be determined based on a known or estimated travel direction or travel path of the sprayer 10, for example as described in US Patent 11477935 the entire contents of which are incorporated herein by reference. US Patent 11477935 describes a variable rate prescription. A spot spray prescription described herein is a special case of a variable rate prescription wherein the spots to be sprayed have a non-zero rate, such as 15 gallons per acre, and the spots that are not to be sprayed have a rate of zero. Generation of a conventional spot spray prescription may include buffering by a first distance in the direction of travel based on estimated nozzle delay timing and may include buffering by a second distance perpendicular to the direction of travel based on desired number of nozzles 20 to activate. Generating a conventional spot spray prescription in this way requires prior knowledge of the direction of travel or the travel path, which is not always available and can be challenging or impossible to estimate accurately for all parts of a field 12. It further requires prior knowledge of boom height, nozzle specifications, nozzle layout, and nozzle delay timing, which are rarely known with confidence at the time of conventional spot spray prescription generation. Incorporating these factors into a conventional spot spray prescription generation further limits use of the spot spray prescription to a single sprayer 10, or a set of sprayers 10 with identical characteristics. Many businesses use multiple sprayers 10 to apply pesticides and other liquids and do not know which sprayer 10 will be used until the day of spraying. Incorporating these factors into a conventional spot spray prescription generation further limits the sprayer to a single type of nozzle 20 corresponding to the nozzle characteristics used for the conventional spot spray prescription generation. It is common to select different nozzles 20 at the time of application based on the selected pesticide or other liquid, temperature, humidity, and wind conditions. For all of these reasons, controlling the nozzles 20 based on spray location data along with real-time dynamic factors 17 and/or and real-time sprayer-specific characteristics 18 is superior to using a conventional spot spray prescription.

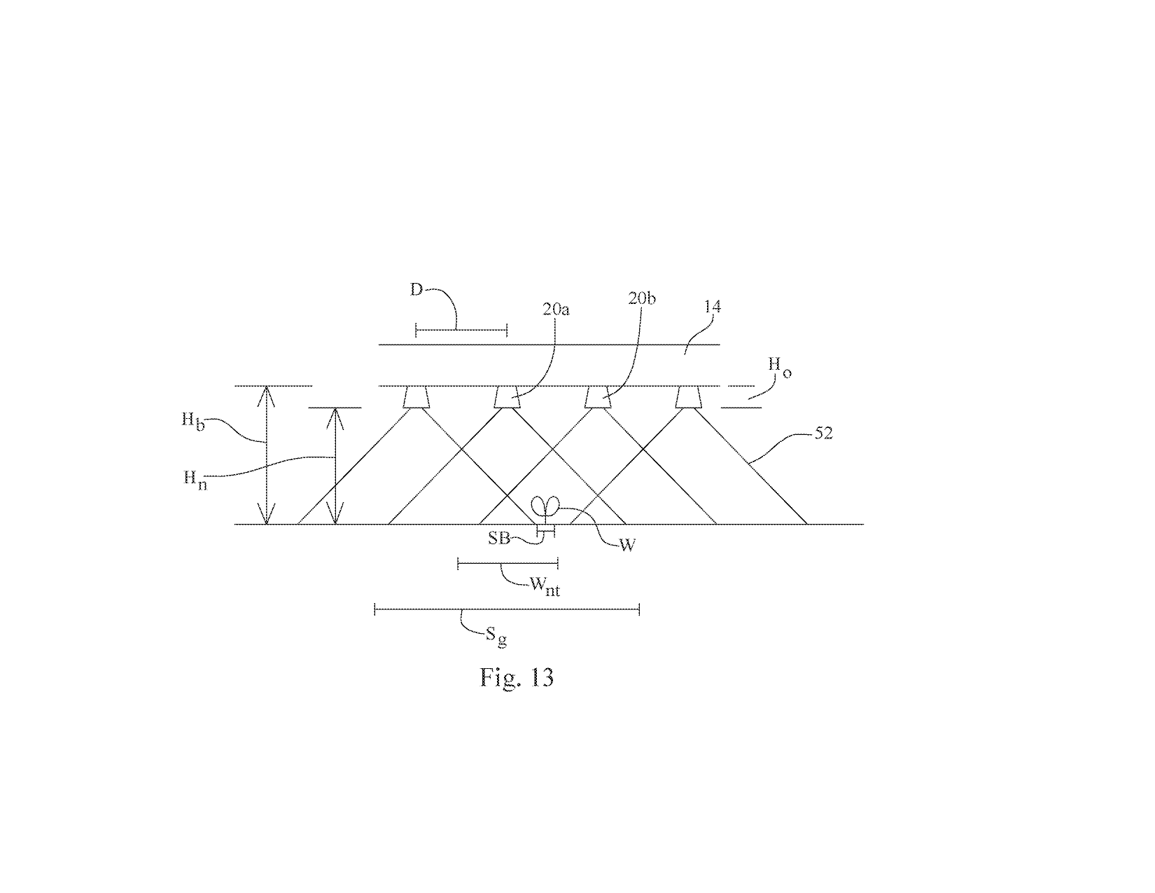

A field computer implementing a conventional spot spray prescription may determine nozzle selection by checking for intersection of each nozzle’s territory width. Referring to FIG. 13, the nozzle territory width Wₙₜ is the distance D between two adjacent nozzles, centered on the nozzle 20a. Depending on boom height and nozzle fan angle, the nozzle’s ground swath S_{g}, or width sprayed, is usually wider than the nozzle territory width Wₙₜ. The ground swath S_{g} is the lateral distance on the ground receiving spray. For a conventional spot spray prescription, the field computer enables nozzle 20a if the nozzle’s territory width Wₙₜ intersects with a spray box SB defined in the conventional spot spray prescription. The spray box SB defines the area to be sprayed which includes the weed W and a buffer space around the weed W. A field computer may require a minimum intersection of 10 centimeters, or a field computer may have no minimum intersection, instead enabling nozzle 20a for any intersection, no matter how small. If the spray box SB is included in the spot spray prescription, the field computer may make a nozzle selection including nozzle 20a but not including nozzle 20b. However, the target dose of herbicide is required to kill the weed W, and the actual dose will be smaller than the target dose because the nozzle 20b is not enabled. In an embodiment of the spot spray control scheme described herein, the nozzle 20a and the nozzle 20b are both included in nozzle selection based on the nozzle characteristics (for example, lateral fan angle) and the boom height H_{b}. Boom height can be measured directly, estimated, or provided as a static value such as a target boom height configured by the sprayer operator. Nozzle height Hₙ can be computed from the boom height H_{b} given a nozzle height offset Hₒ. The nozzle height offset Hₒ is generally small, so the terms boom height H_{b} and nozzle height Hₙ may be used interchangeably. Boom height can be measured from the bottom of the spray boom 14, the center of the spray boom 14, the bottom of the nozzle 20, the center of the nozzle 20, or a location corresponding to the point of a triangular or conical spray pattern. In an embodiment, the boom height used in the spot spray control scheme described herein includes the nozzle height offset.

In contrast, unlike a conventional spot spray prescription, in the techniques described herein, the spray location data, such as the list of weed locations, and one or more of dynamic factors 17 during operation of the sprayer and/or one or more sprayer-specific characteristics of the sprayer are used to control nozzle operation. For example, in an embodiment, the techniques described herein allow the system to calculate, in real-time and after the spray location data is determined and possibly loaded onto the agricultural sprayer 10, buffers to be applied to the spray location data based on the one or more dynamic factors 17 and/or the one or more sprayer-specific characteristics 18. The same spray location data, such as the list of weed locations, can be provided to different agricultural sprayer systems each with different dynamic factors 17 and sprayer-specific characteristics 18 that can be used to determine buffers to be applied to the spray location data. In another embodiment, the spray location data that is loaded onto the agricultural sprayer 10 may not have any pre-generated buffers applied to the spray location data. In another embodiment, the spray location data that is loaded onto the agricultural sprayer 10 may have pre-generated buffers applied to the spray location data, and the techniques described herein may modify those pre-generated buffers. For example, pre-generated buffers can be generated that account for error, such as spatial error described below, in the UAV’s estimation of where the weed locations are.

The spray location data, for example the list of weed locations, can be stored in any suitable file format including, but not limited to, an ESRI shapefile, an ESRI Geodatabase, a geopackage, a geoparquet, GeoJSON, or CSV, or a proprietary file format. Locations can be stored as points, quadrilaterals such as bounding boxes, or polygons. Each location may contain additional information such as estimated spatial error. Bounding boxes may become non-rectangular when projected. In the example of a weed locations file, if the weed locations file is determined from UAV imagery, the locations will be subject to spatial error due to factors like UAV position error, altitude estimation error, terrain estimation error, lens model error, and the like. The spot spray control module 38 may incorporate the estimated spatial error of the weed locations file to ensure spray coverage over all locations where the weed may actually be, within the error tolerance of the stated location.

As explained above, the spot spray control module 38 determines nozzle selection, nozzle state change timing, and nozzle flow rate. Nozzle selection refers to determining which nozzles to turn on. Nozzle state change timing refers to determining when a nozzle 20 should be turned on or off. Nozzle flow rate refers to the volume of liquid flowing through the nozzle per unit time (e.g. gallons per second). Fields are prescribed a target spray rate in volume per area (e.g. gallons per acre), such as 15 gallons per acre of herbicide. Spray rate is determined by nozzle height, nozzle spray pattern including in-line fan angle and lateral fan-angle, nozzle velocity, and contributions from adjacent nozzles. The nozzle flow rate may compensate for speed variations caused by turns of the agricultural sprayer. Modern agricultural sprayers 10 adjust the flow from individual nozzles 20 based on the speed of movement of individual nozzles 20. During a turn of the agricultural sprayer 10, the inside nozzles 20 are moving at a different rate than the outside nozzles 20 (i.e. the inside nozzles 20 are moving more slowly while the outside nozzles 20 are moving more quickly). Due to this difference in travel rate, the inside nozzles 20 are controlled to reduce their spray volume per second while the outside nozzles 20 are controlled to increase their spray volume per second. This technique is known as turn compensation. In current practice, turn compensation assumes a rigid spray boom 14 and estimates nozzle velocity based on a single navigation sensor 34 and the turn rate of the sprayer 10.

Spray reaching the surface is also affected by boom dynamics such as forward and backward swinging movements of the spray boom 14 and/or up and down swinging movements of the spray boom 14. A consistent spray rate is desirable to ensure a sufficient dose to treat the agricultural field 12 and avoid an excessive dose which can injure the crop or be detrimental to the environment. As the spray boom 14 moves forward and backward, the nozzles 20 on the spray boom 14 are traveling at a different velocity than the sprayer 10. If the nozzles 20 are moving faster relative to the ground, such as when the spray boom 14 is swinging forward, a fixed nozzle flow rate results in a reduced surface spray rate. If the nozzles 20 are moving slower relative to the ground, such as when the spray boom 14 is swinging backward, a fixed nozzle flow rate results in an increased surface spray rate. If the spray boom 14 is rotating upward, the nozzle height relative to the ground is increased and a fixed nozzle flow rate results in a decreased surface spray rate because the spray pattern spreads over a larger area. If the spray boom 14 is rotating downward, the nozzle height relative to the ground is decreased and a fixed nozzle flow rate results in increased surface spray rate because the spray pattern spreads over a smaller area. Therefore, the nozzle flow rate (as well as nozzle selection and nozzle state change timing) that is determined may also compensate for boom flexure/sway (forward, backward, upward, downward), based on data from one or more of the sensors 30, 34 even when the sprayer 10 is not turning, in order to achieve consistent application rates. Nozzle flow rate can be controlled using pulse width modulation (PWM) wherein the valve is commanded to open and close at a frequency and duty cycle. Common frequencies for sprayer PWM systems are in the range of 10Hz to 100Hz. Common duty cycles are in the range of 2% to 100%. If the target spray rate is 15 gallons per acre, and the spray system is estimated to apply 30 gallons per acre if the valves are open, the nozzle flow rate can be reduced by controlling the valve with a 50% PWM duty cycle to achieve a spray rate of 15 gallons per acre. Nozzle selection, and nozzle state change timing, and nozzle flow rate can be determined using nozzle locations and nozzle velocities that are computed based on spray boom dynamics.

Examples of dynamic factors 17 that may be used, with the spray location data, to control operation of the nozzles 20 include, but are not limited to, one or more of boom height, nozzle velocity, and air velocity. The boom height can be determined using the boom height sensor(s) 30. The nozzle velocity refers to the speed of travel of the nozzles which can be determined by the navigation sensor(s) 34. The air velocity can be determined using the air velocity sensor(s) 32. In an embodiment, air velocity can be provided from one or more external systems (i.e. external to the sprayer 10), such as a weather station at or nearby the agricultural field 12. If the air velocity is provided from one or more external systems, the externally provided air velocity may be used by itself, used together with measurements from the sensors 32, or used to modify the measurements from the sensors 32.

Examples of sprayer-specific characteristics 18 that may be used to modify the spray data 11 to generate the modified spray data 13 include, but are not limited to, one or more of nozzle specifications, nozzle delay timing, and nozzle layout.

Nozzle specifications refers to information about each nozzle including, but not limited to, a nozzle’s size, droplet size, orientation, lateral fan angle, in-line fan angle, or other characteristics. Lateral is a dimension parallel to the length of the spray boom, while in-line is a dimension parallel to the direction of travel of the agricultural sprayer 10.

Nozzle delay timing refers to a time that elapses between when a nozzle is commanded on and when spray reaches a surface (such as the crop, the weed, the ground, or the like). Similarly, time elapses between when a nozzle is commanded off and when spray stops reaching a surface. This delay time has several components. One component is the time from when the nozzle location was sampled to when the command is issued by the spot spray control module 38. Another is the time from when the spot spray control module 38 issues a command and when the central control module 22 receives a command. Another is the time from when the central control module 22 receives a command to when it issues a command. Another is the time from when the central control module 22 issues a command to when the valve control module 24 receives the command. Another is the time from when a valve control module 24 receives a command and when it drives the nozzle valve. Another is the time for the nozzle valve to mechanically actuate. Another is the time for pressure in the system hoses or plumbing to adjust. Another is the time from when a spray droplet is formed in the nozzle 20 to when it reaches the surface (crop, weed, ground, etc.). These time delays can be measured or estimated independently or measured or estimated together as a group, or a subset of segments of the delay can be measured or estimated as a group. The resulting measurements or estimations can be provided to the spot spray control module 38 and used to determine nozzle state change timing (i.e. determining when a nozzle should be turned on or off).

In current practice, nozzle delay timing measurements are made by an observer with a stopwatch who watches an agricultural sprayer 10 configured to spray at a known location. The observer measures the time between spray on (or off) and spray location using a stopwatch. This time is entered into the system as an adjustment to the delay configuration in use during the observation. This method is error prone because it relies on human reflex time to press the stopwatch start and stop button. In current practice, nozzle delay timing is sometimes referred to as look-ahead on time, look-ahead off time, on delay time, and off delay time. In current practice, these nozzle delay timings are stored on a field computer 26 and the field computer 26 uses these conventional nozzle delay timings to determine nozzle state change timing with respect to a conventional spot spray prescription.

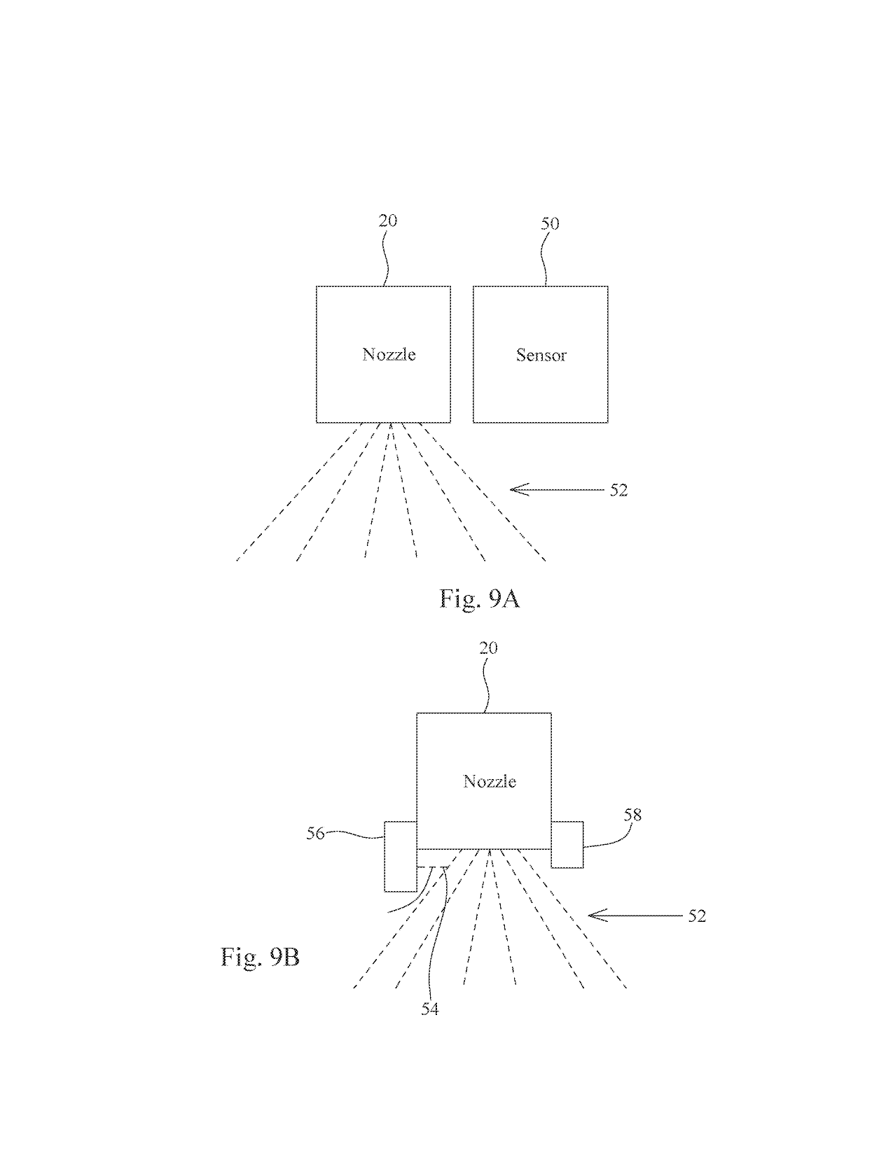

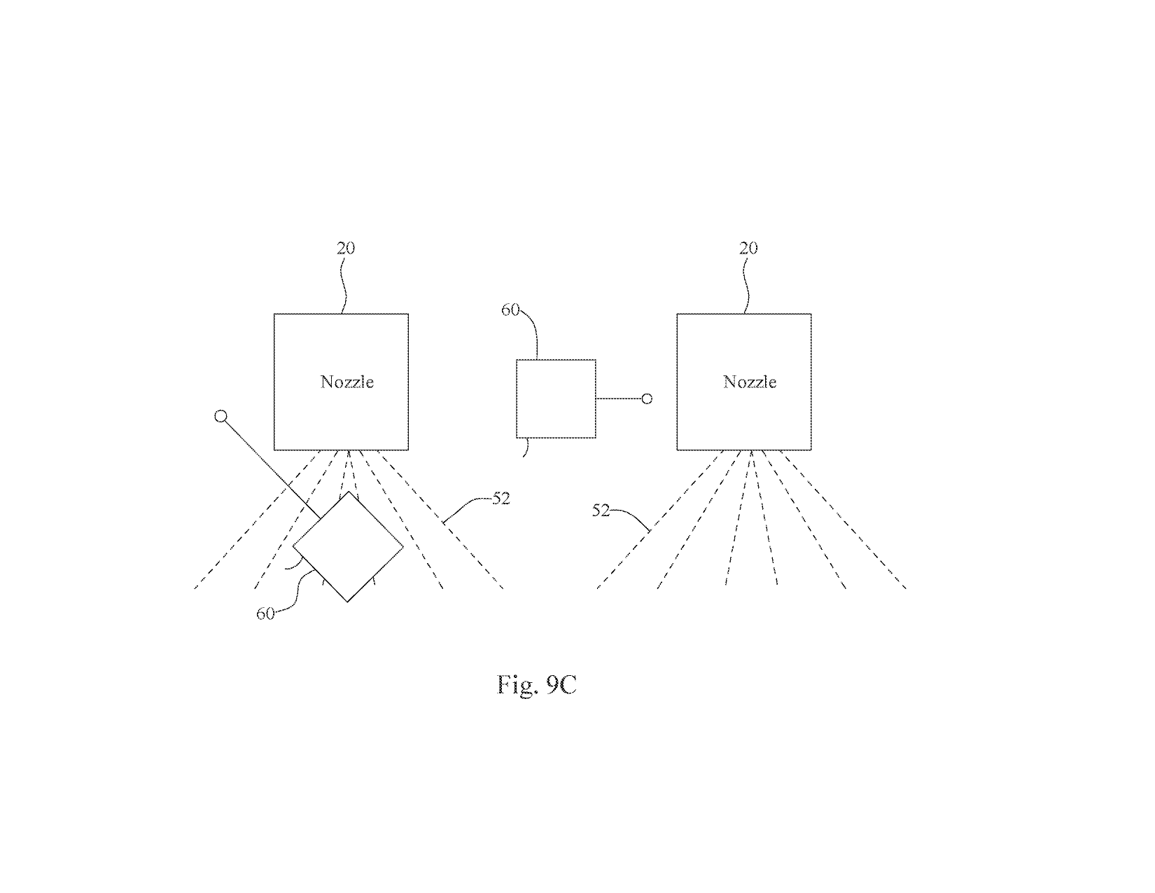

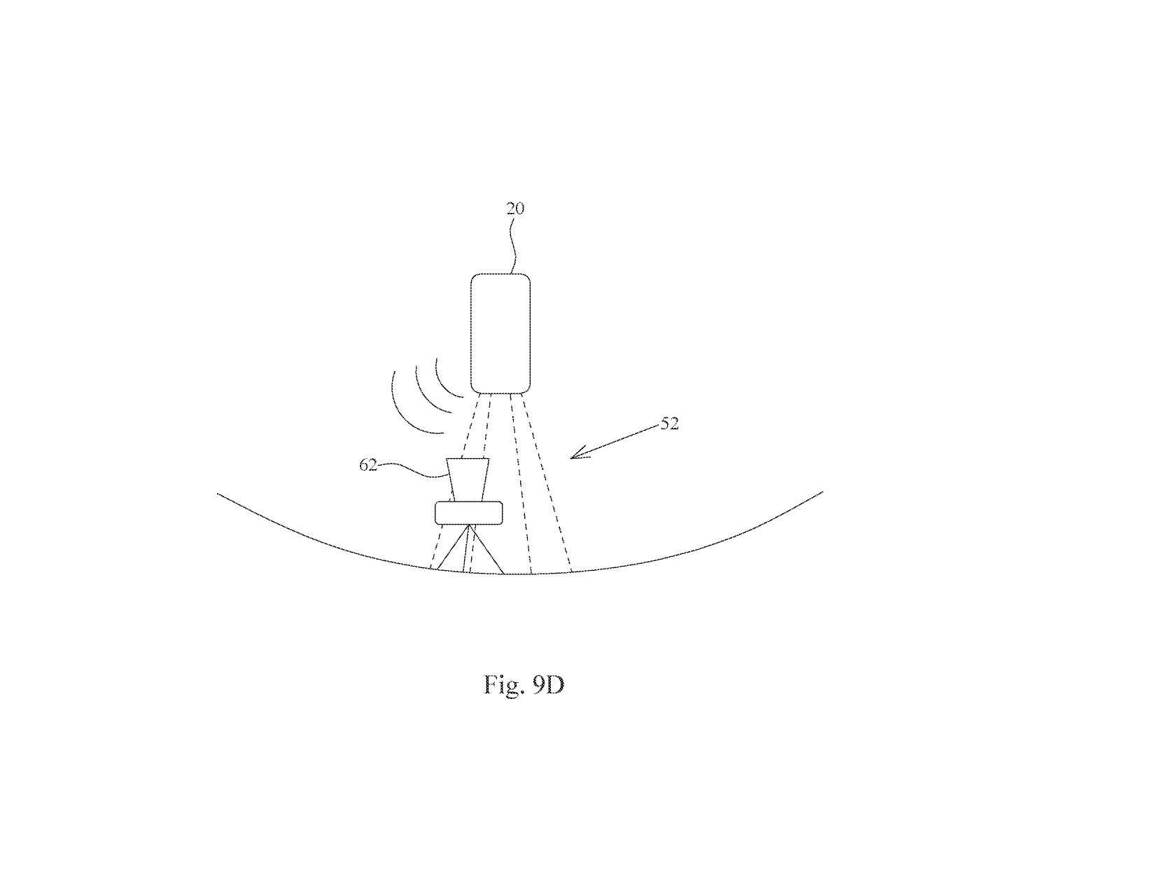

Instead of using a stopwatch, the nozzle delay timing measurement can be achieved by mounting a sensor 50 near the nozzle 20 to detect nozzle on time and nozzle off time and record a timestamp for each time as depicted in FIG. 9A. The recorded timestamp for detecting nozzle on is compared to the timestamp for when the nozzle 20 was commanded on to determine the nozzle on delay. The recorded timestamp for detecting nozzle off is compared to the timestamp for when the nozzle 20 was commanded off to determine the nozzle off delay. In one embodiment the sensor 50 may be a video camera, and the camera feed is processed to observe the start and stop of spray 52 from the nozzle 20. All video frames have a timestamp. The timestamp of spray start observed by the camera is compared to the timestamp of the spray start command to determine the nozzle on delay time. Similarly, the timestamp of spray stop observed by the camera is compared to the timestamp of the spray stop command to determine the nozzle off delay time.

A video camera is not the only sensor 50 that can detect spray. Spray on/off timing can be measured with a thermal sensor, a moisture sensor, a humidity sensor, a liquid sensor, a sonar, a microphone, an optical sensor, a laser, or a beam breaking sensor. Referring to FIG. 9B, in an embodiment an optical beam 54, such as from a laser or an infrared light, is generated to traverse the spray pattern, and spray timing is determined when the optical beam 54 is broken or disturbed. The beam break sensor may include an emitter 56 and a receiver 58. In an embodiment, a processor connected to a microphone determines spray on and off timing based on detecting the audible actuation of the nozzle valve.

A sensor 50 can measure spray 52 in the air, or a sensor 50 can include a surface that intercepts spray 52 and measures the presence of spray 52 on the surface. The sensor 50 can be installed in a fixed location or can be mechanically retractable or stowable. A stowable sensor 60 can directly detect presence of spray 52 through contact during calibration, but would inhibit spray 52 reaching the target during normal operation. FIG. 9C depicts an example of a stowable sensor 60. In this example, the stowable sensor 60 is retracted to a stowed position during normal operation (right side of FIG. 9C), and is actuated to a deployed position (left side of FIG. 9C) in the path of the spray 52. A stowable sensor 60 could also include a surface that is moved by the spray 52, and the stowable sensor 60 detects the spray timing by detecting motion of the surface. A stowable sensor 60 can be inside the spray pattern, such as in a mechanically retractable installation which is retracted when not performing nozzle delay timing measurements, or outside the spray pattern. Nozzle delay measurements can occur when the agricultural sprayer 10 is moving or when the agricultural sprayer 10 is stationary. The nozzle delay measurements can occur during a calibration operation, or continuously or periodically during normal operation of the agricultural sprayer 10. A calibration operation can occur once when the spray system is manufactured, or when a nozzle control system is installed, can occur once per year, once per day, or at some other time interval.

Instead of mounting the sensor 50 on the sprayer, the sensor 50 can be installed on the ground. For example, referring to FIG. 9D, a fixed calibration sensor 62 or sensors, such as a video camera, may be placed within a targeted spray area at the application surface. The fixed calibration sensor 62 may record both the time at which the sensor 62 is sprayed by the nozzle 20 and the time at which the spray boom 14 is in alignment with the sensor 62. In one embodiment, the sensor 62 may include a water-resistant video camera and a water-resistant microphone. The audio feed may be processed to determine when the spray 52 starts based on the sound of the nozzle valve, and the video detects when the spray boom 14 is directly over the fixed calibration sensor 62.

The nozzle delay timing measurement can be performed for a single one of the nozzles 20, a plurality of the nozzles 20, or all of the nozzles 20. In one embodiment, a single nozzle on-delay measurement and a single nozzle off-delay measurement can be applied to all of the nozzles 20. A plurality of the nozzles 20 may be selected from camera observation, such as the center nozzle and the leftmost and rightmost nozzle. Then nozzle delays for other nozzles 20 may be determined based on their position relative to the measured nozzles, such as by linear interpolation. It is possible that each section of nozzles 20 or each valve control module 24 will have a different delay. Cameras may be installed for one nozzle per section, or one nozzle per valve control module 24.

Nozzle layout refers to the relative position of the nozzles 20 with respect to the spray boom 14, or with respect to the navigation sensors 34. Each nozzle location is computed by combining the location data from the navigation sensors 34 and the nozzle layout. In current practice, the spray boom 14 is assumed to be rigid and mounted in parallel with the sprayer’s wheel axles, and each nozzle location is computed by combining the nozzle position relative to a single navigation sensor 34 with the location and orientation of the navigation sensor 34, sometimes referred to as a lever arm calculation. These assumptions are accurate enough for many applications. However, they are not accurate enough to deliver ideal results for spot spraying, and they are detrimental to achieving consistent spray rate in broadcast applications. In a broadcast application, a consistent spray rate is applied to a large area of the field rather than spraying spots.

To improve accuracy, the location of each nozzle 20 can be computed using a spray boom dynamics model. A spray boom dynamics model includes a description of how the spray boom 14 is positioned, oriented, and contoured, and includes methods for computing the location of nozzles 20 along the spray boom 14 in light of its position, orientation, and contour. Spray boom dynamics includes movement and flexure (deformation) of the spray boom 14 relative to the assumption of a rigid spray boom mounted parallel to the sprayer’s wheel axles, whether such deformation occurs due to forces acting on the structure or due to intentional articulation of the spray boom 14 to compensate for variation in terrain or other factors. Movement includes spray boom translation or rotation in any direction or sense relative to mounting and pivot points, such as horizontal translation or rotation forward or backward or clockwise or counterclockwise when the sprayer 10 begins driving, stops driving, or changes driving speed. Movement includes spray boom translation or rotation up or down such as when driving over rough terrain. Flexure refers to the bending of the spray boom material itself. In one embodiment, instead of using a single navigation sensor 34 and assuming a rigid spray boom 14, nozzle location is computed by interpolating between the location of two navigation sensors 34, which provides a more accurate nozzle location than the rigid spray boom 14 assumption. Spray boom dynamics may include horizontal rotation, vertical rotation, and flexure all at the same time.

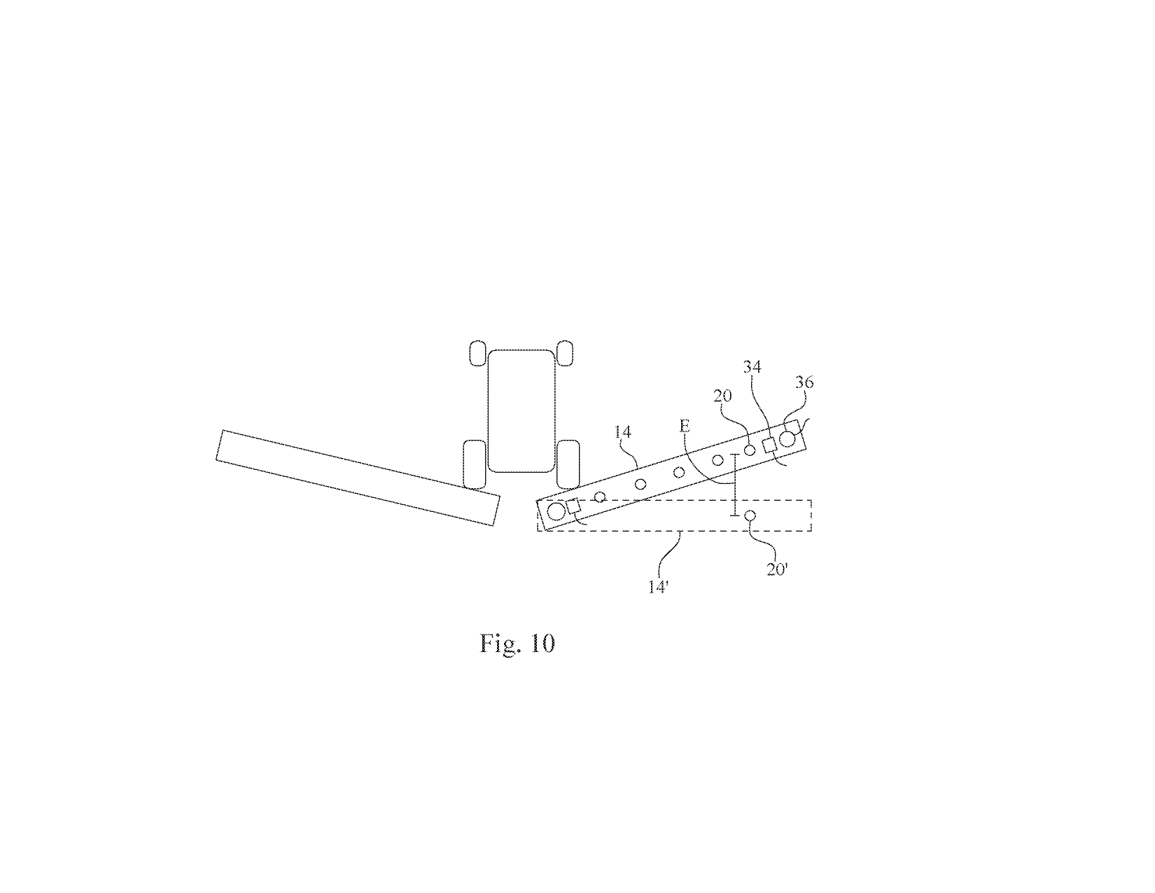

FIG. 10 is a top view of a spray boom 14 that is rotated forward due to boom dynamics. FIG. 10 shows the true location of a nozzle 20 of the spray boom 14, the location of the nozzle 20’ that would be calculated assuming a rigid spray boom 14’, and the horizontal error E between the two locations due to forward swing of the spray boom 14. For example, the horizontal error E can be 10 centimeters, 50 centimeters, 1 meter, or 2 meters. Horizontal and vertical errors are sometimes referred to as horizontal and vertical displacement. The true location of the nozzle 20 can be calculated using a boom dynamics model. The boom dynamics model’s methods for computing nozzle location can include interpolation, such as linear interpolation, polynomial interpolation, or spline interpolation. In one embodiment, the location of the nozzle 20 is computed using linear interpolation between the location of two navigation sensors 34.

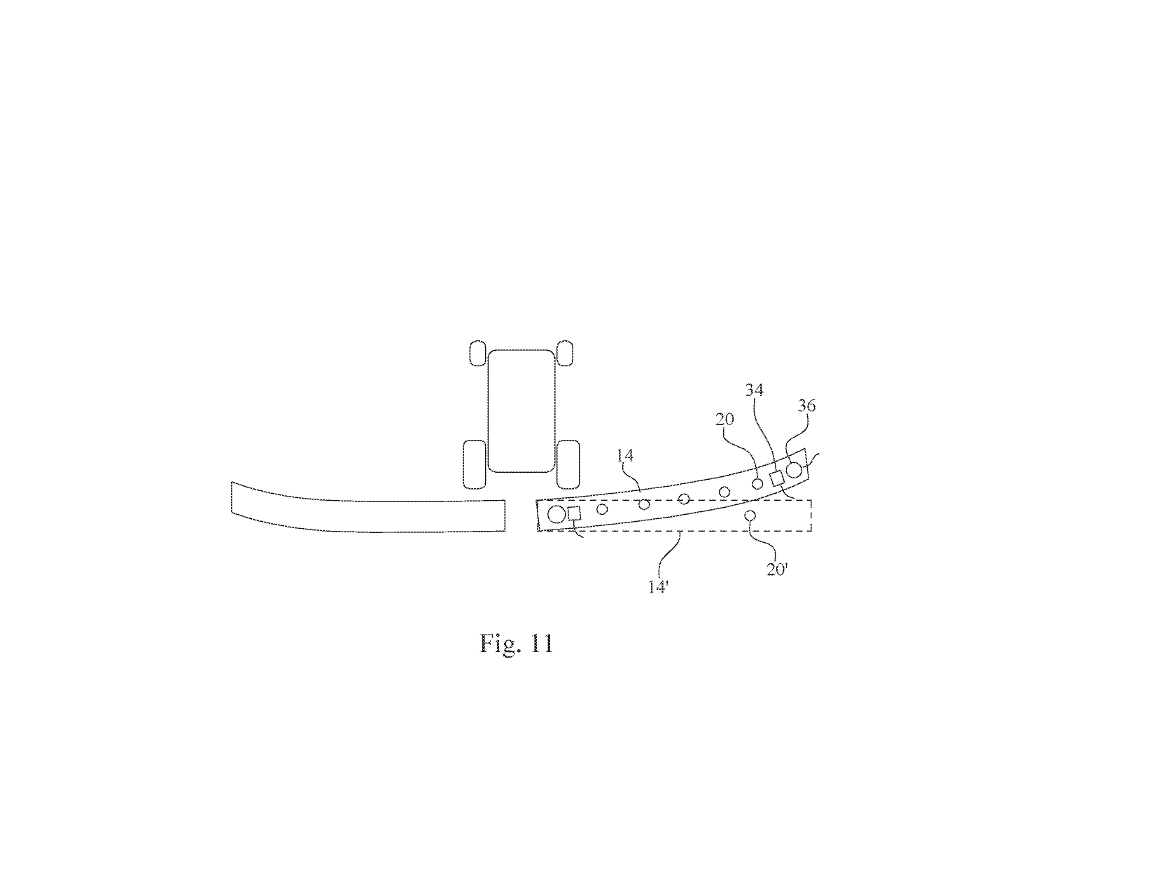

FIG. 11 is a top view of a spray boom 14 that is affected by motion (e.g. rotated forward) and affected by flexure (i.e. bent forward). The true location of the nozzle 20 differs from the location of the nozzle 20’ assuming a rigid spray boom, and the true location of the nozzle 20 can be computed using a polynomial interpolation or a spline interpolation. The parameters of the polynomial interpolation or the spline interpolation can be determined dynamically using additional navigation sensors 34 or can be determined (modeled) using knowledge of the spray boom characteristics and how the spray boom 14 bends under various circumstances. In addition to nozzle location, nozzle velocity relative to the ground can be computed using the boom dynamics model. In an embodiment, nozzle velocity may be computed using the current nozzle location, previous nozzle location, and time elapsed between samples. In another embodiment, nozzle velocity may be computed using a more sophisticated model. Additional boom dynamics model methods are described in “Impact of the horizontal movements of a sprayer boom on the longitudinal spray distribution in field conditions”, Ooms et al., Crop Protection, 2003; and “Sprayer Boom Motion, Part 1: Derivation of the Mathematical Model using Experimental System Identification Theory”, Clijmans et al., Journal of Agricultural Engineering Research, 2000.

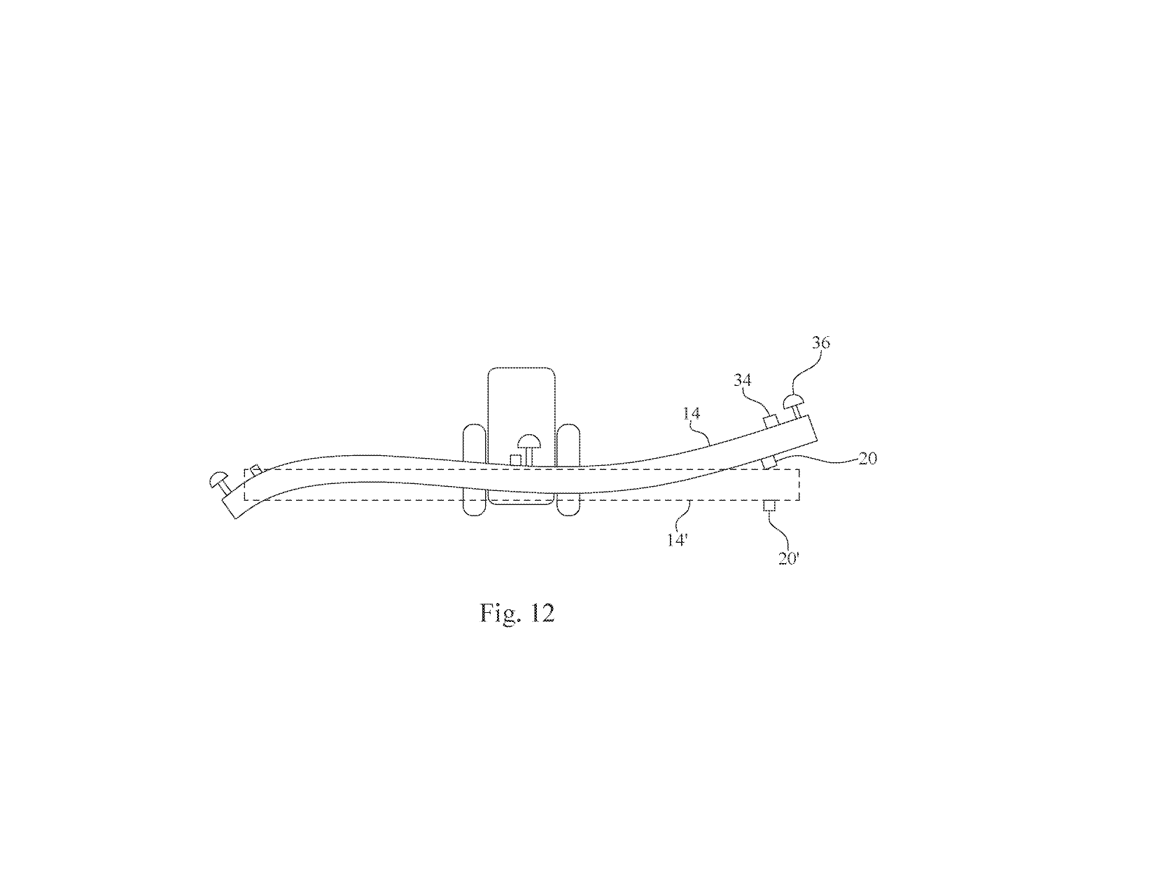

FIG. 12 is a rear view of a spray boom 14 that is affected by motion, in particular upward and downward rotation as well as upward and downward flexure. The true location of the nozzle 20 differs from the location of the nozzle 20’ assuming a rigid spray boom 14, and the true location of the nozzle 20 can be computed using any of the techniques described above.

Referring to FIG. 8, the agricultural sprayer 10 may have section control, meaning that groups of the nozzles 20 are controlled together as a section. The example depicted in FIG. 8 shows six sections, with five of the sections having four nozzles and one section having three nozzles. Each of the sections can have the same number of nozzles 20 as one another, each of the sections can have a different number of nozzles 20 from one another, or some sections can have the same number of nozzles 20 while other sections can have a different number of sections. The sections can be turned on and off independently. In an embodiment, the nozzles 20 within a section may not be individually controllable whereby if one nozzle 20 in a section is on, all nozzles 20 in that section are also on. In another embodiment, the nozzles 20 in any section may be individually controllable. In an embodiment, instead of the nozzles 20 being grouped into sections, each nozzle 20 on the spray boom 14 may be individually controllable.

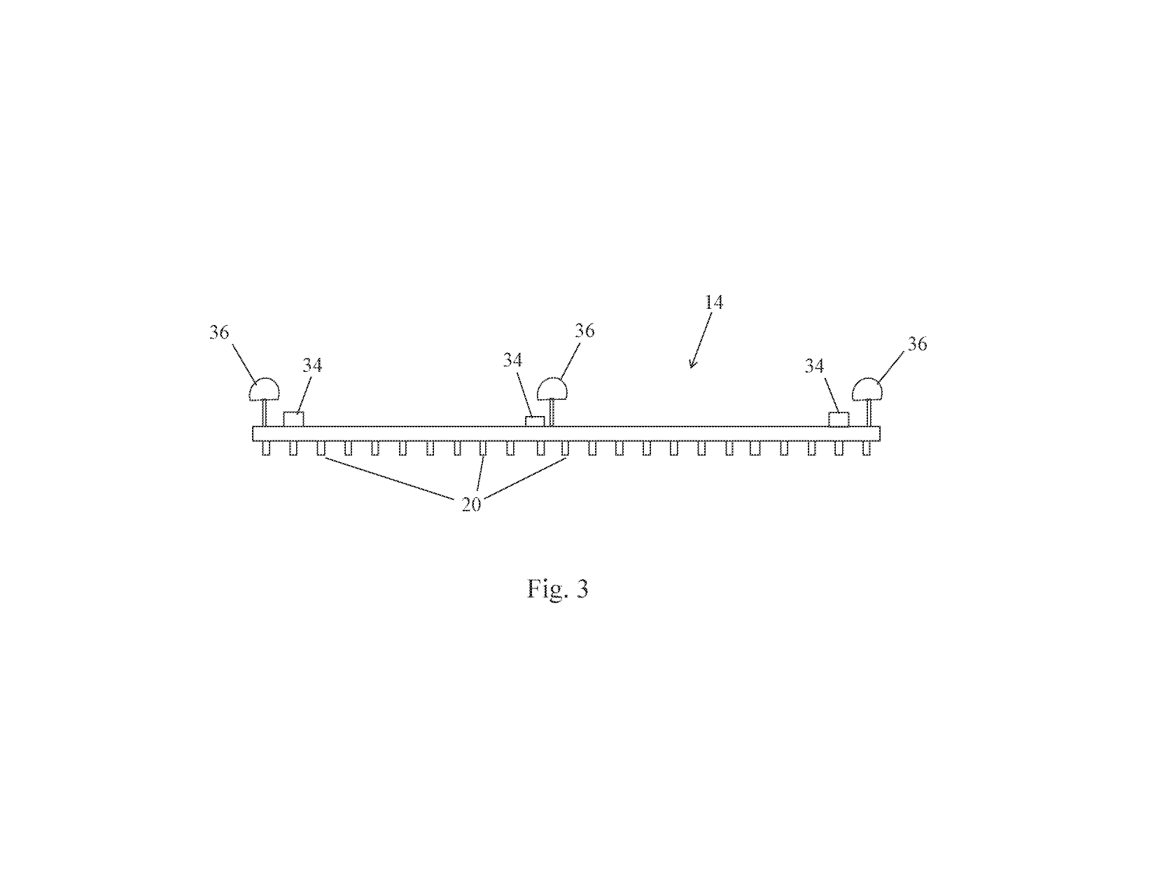

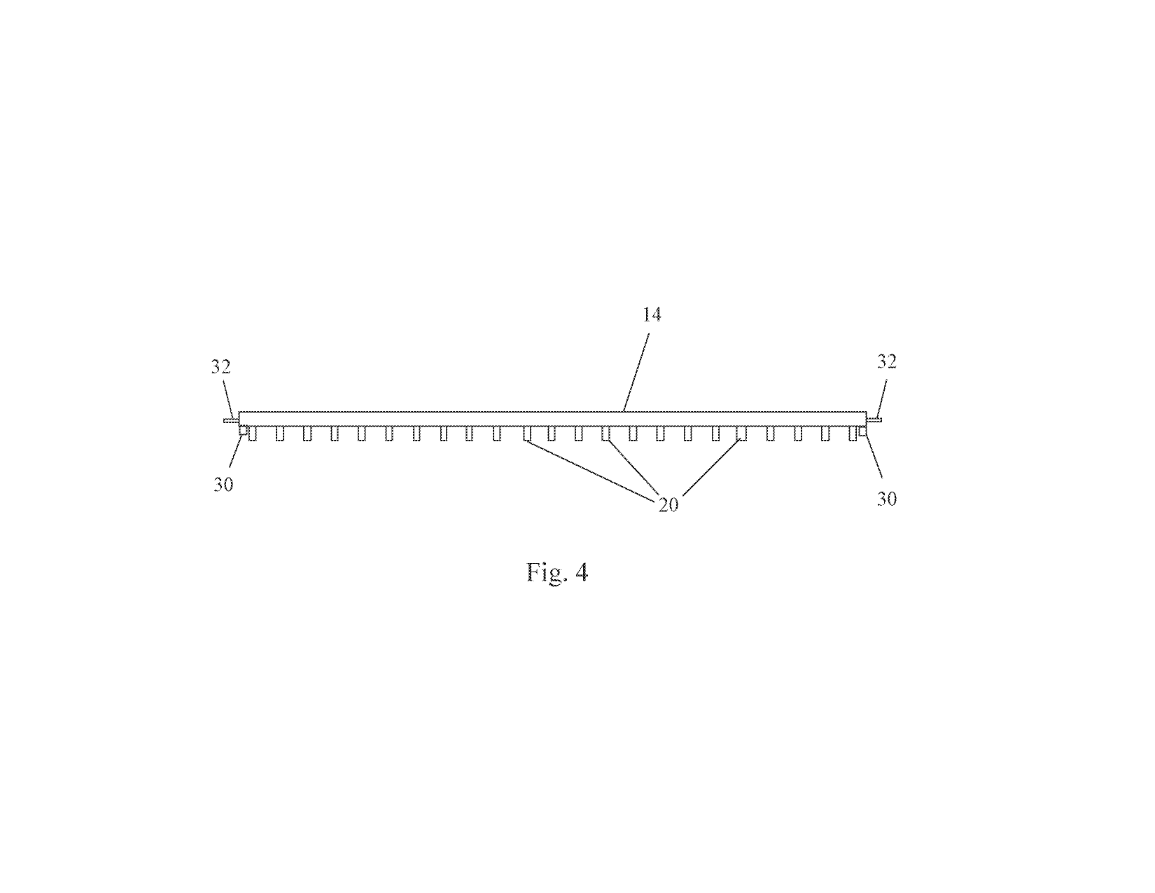

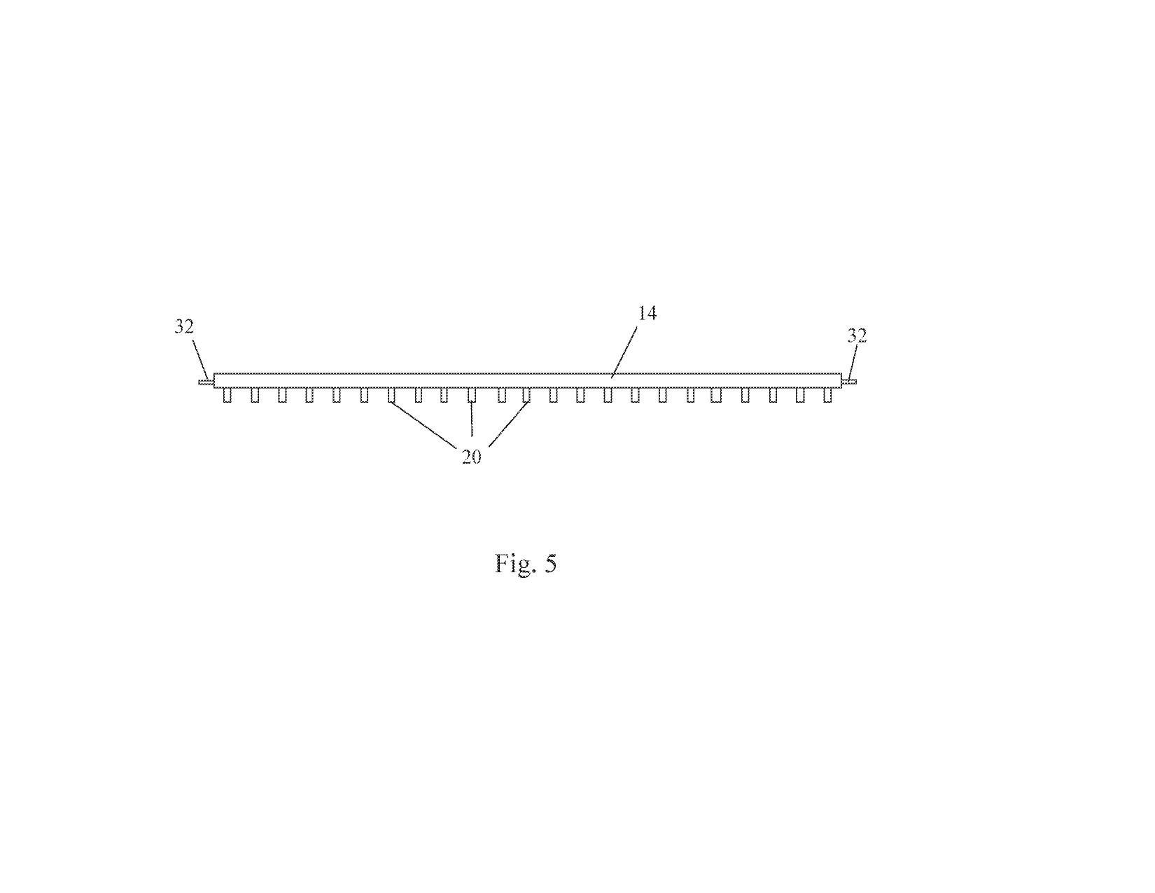

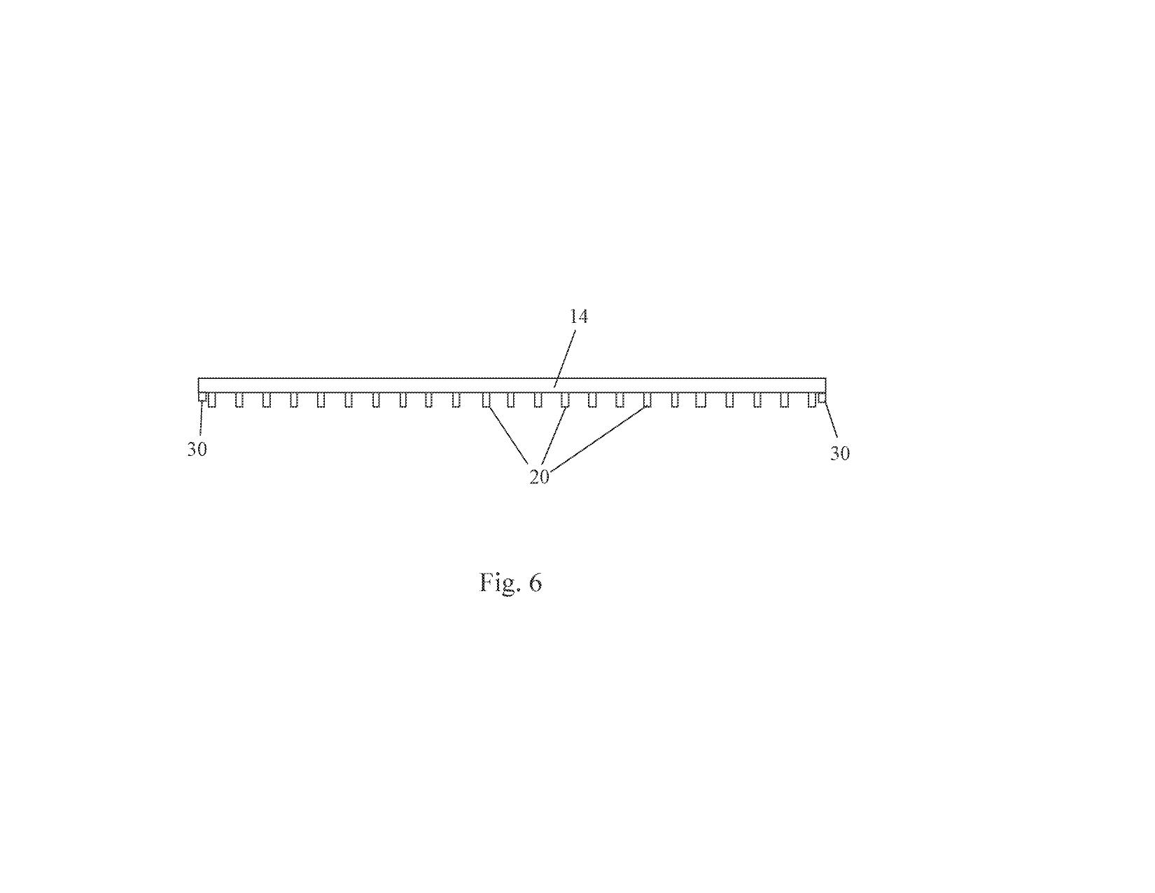

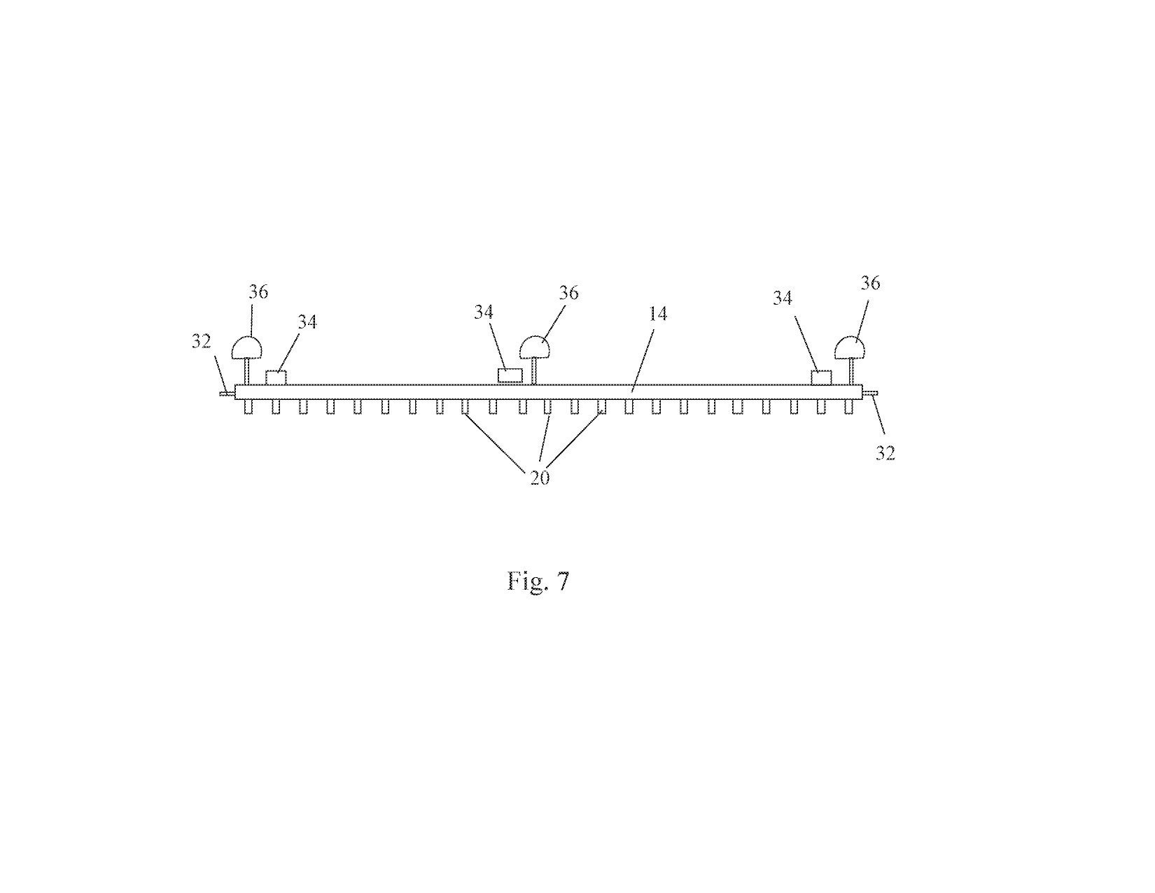

Variations of the spray boom 14 are possible, and the spray boom 14 can include any combination of the sensors described herein. For example, referring to FIG. 3, the spray boom 14 is depicted as including the navigation sensor(s) 34 and the GNSS antenna(s) 36, without the boom height sensors 30 and the air velocity sensors 32. Referring to FIG. 4, the spray boom 14 is depicted as including the boom height sensors 30 and the air velocity sensors 32 without the navigation sensor(s) 34 and the GNSS antenna(s) 36. Referring to FIG. 5, the spray boom 14 is depicted as including the air velocity sensors 32 without the boom height sensors 30, the navigation sensor(s) 34 and the GNSS antenna(s) 36. Referring to FIG. 6, the spray boom 14 is depicted as including the boom height sensors 30 without the air velocity sensors 32, the navigation sensor(s) 34 and the GNSS antenna(s) 36. Referring to FIG. 7, the spray boom 14 is depicted as including the navigation sensor(s) 34, the GNSS antenna(s) 36, and the air velocity sensors 32, without the boom height sensors 30.

In an embodiment, the spray instructions file that is stored on the spray boom 14 and used to control the nozzles 20 may be a spot spray prescription representing the entire area to be sprayed (rather than the location of the weed).

In an embodiment, the spray instructions file that is stored on the spray boom 14 and used to control the nozzles 20 may be a list of locations. In an embodiment, the list of locations may include one or more of points, quadrilaterals, or polygons. In an embodiment, the list of locations may include an estimated spatial error determined for each location, or an estimated spatial error that is applied to all locations. The estimated spatial error may be stored as supplemental data alongside the original locations, or the estimated spatial error may be used to modify the locations such as by applying a buffer corresponding to the estimated spatial error.

In an embodiment, a controller 21 can compute or receive one or more of boom height, nozzle velocity, nozzle characteristics, nozzle delay timing, nozzle layout, air velocity, and spatial error, and may determine nozzle flow rate, nozzle state change timing, and/or nozzle selection based on one or more of them.

In an embodiment, the spray instructions file that is stored on the spray boom 14 and used to control the nozzles 20 may be include an estimated spatial error.

In an embodiment, the controller 21 can compute the velocity of each nozzle, and determine the timing of a nozzle state change based on the velocity of the nozzle.

In an embodiment, the controller 21 can compute the velocity of each nozzle, and determine the nozzle flow rate based on the velocity of the nozzle.

In an embodiment, the controller 21 can receive boom height, and determine nozzle state change timing based on the boom height.

In an embodiment, the controller 21 can receive boom height, and determine nozzle selection based on the boom height.

In an embodiment, the controller 21 can receive boom height, and determine nozzle flow rate based on the boom height.

In an embodiment, the controller 21 can receive one or more nozzle specifications, and determine one or more of nozzle selection, nozzle flow rate, and nozzle state change timing based on the one or more nozzle specifications.

In an embodiment, a spot stray control system 15 described herein can include one or more air velocity sensors 32, and the system is configured to determine one or more of nozzle selection, nozzle flow rate, and nozzle state change timing.

In an embodiment, a spot spray control system 15 described herein can include one or more boom height sensors 30, and the system is configured to determine one or more of nozzle selection, nozzle state change timing, and nozzle flow rate based on the detected boom height.

In an embodiment, a spot spray control system 15 described herein can include two navigation devices 34, one navigation device installed on each end of the spray boom 14. In an embodiment, the system can include three navigation devices 34, one installed on each end of the spray boom 14 and one installed near the center of the spray boom 14.

The examples disclosed in this application are to be considered in all respects as illustrative and not limitative. The scope of the disclosure is indicated by the appended claims rather than by the foregoing description; and all changes which come within the meaning and range of equivalency of the claims are intended to be embraced therein.

1. A system comprising:
an agricultural sprayer that includes a spray boom with nozzles that are controllable to be turned on and off;
spray data stored on the agricultural sprayer; and
a controller on the agricultural sprayer that is connected to and controls operation of the nozzles to spray a liquid based on the spray data and one or more of the following:
a) one or more dynamic factors;
b) one or more sprayer-specific characteristics of the agricultural sprayer.

2. The system of claim 1, further comprising a sensor for capturing spray data and providing the spray data to the agricultural sprayer prior to operation of the nozzles.

3. The system of claim 2, wherein the sensor is configured to determine a nozzle delay timing by detecting and comparing a nozzle on time and a nozzle off time.

4. The system of claim 2, wherein the sensor comprises a camera and is coupled to an unmanned aerial vehicle.

5. The system of claim 1, wherein the one or more dynamic factors comprise one or more of a buffer, a boom height, a nozzle velocity, and an air velocity.

6. The system of claim 1, wherein the one or more sprayer-specific characteristics comprise one or more of a nozzle height, nozzle delay timing, nozzle specifications, and nozzle layout.

7. The system of claim 5, further comprising a boom height sensor coupled to the agricultural sprayer and configured for determining the boom height.

8. The system of claim 5, further comprising at least two navigation sensors coupled to the agricultural sprayer and configured for determining a nozzle location by interpolating between the location of two navigation sensors.

9. The system of claim 5, further comprising an air velocity sensor coupled to the agricultural sprayer and configured for determining the air velocity.

10. A system comprising:
an agricultural sprayer that includes a spray boom with nozzles that are controllable to be turned on and off;
spray data stored on the agricultural sprayer; and
a controller on the agricultural sprayer that is connected to and controls operation of the nozzles to spray a liquid based on the spray data, nozzle specifications, and boom height.

11. The system of claim 10, further comprising a sensor for capturing spray data and providing the spray data to the agricultural sprayer before the operation of the nozzles.

12. The system of claim 11, wherein the sensor comprises a camera.

13. The system of claim 11, wherein the sensor is coupled to an unmanned aerial vehicle.

14. The system of claim 10, further comprising a boom height sensor coupled to the agricultural sprayer and configured for determining the boom height.

15. The system of claim 10, further comprising a navigation sensor coupled to the agricultural sprayer and configured for determining a nozzle velocity.

16. An agricultural sprayer comprising:
a spray boom;
one or more nozzles coupled to the spray boom;
at least one tank for storing a liquid;
a pump for providing the liquid to the nozzles from the tank; and
a spot spray control system comprising:
a navigation sensor coupled to the spray boom and configured to determine a position;
a boom height sensor coupled to the spray boom and configured to determine a boom height; and
a controller in communication with the navigation sensor for receiving the position and the boom height sensor for receiving the boom height, the controller configured to receive a spray data, a nozzle specification, and a nozzle layout, determine a modified spray data based on the position, the boom height, the spray data, the nozzle specification, and the nozzle layout, and control the nozzles according to the modified spray data.

17. The agricultural sprayer of claim 16, further comprising the controller receiving one or more sprayer-specific characteristics that comprise one or more of a nozzle height, and nozzle delay timing to determine the modified spray data.

18. The agricultural sprayer of claim 16, further comprising a sensor for capturing the spray data and providing the spray data to the agricultural sprayer prior to operation of the nozzles

19. The agricultural sprayer of claim 16, wherein the controller comprises a central control module for controlling the pump by varying the pump speed or turning the pump on or off and for controlling the nozzles via a valve control module; a field computer for receiving operator input and for controlling the central control module according to the operator input; a spot spray control module in communication with the field computer and configured to receive spray data,
the valve control module controls the operation of the nozzles to spray the liquid.

20. The agricultural sprayer of claim 18, wherein the sensor is configured to determine a nozzle delay timing by detecting and comparing a nozzle on time and a nozzle off time.
